(19) United States
(12) Patent Application Publication
(10) Pub. No.: US 2013/0244669 A1
(43) Pub. Date: Sep. 19, 2013

(54) CONFIGURATION CONTROL FOR SMALL-AREA CELL WIRELESS NETWORK

(71) Applicant: QUALCOMM INCOPORATED, San Diego, CA (US)

(72) Inventors: Soumya Das, San Diego, CA (US); Samir S. Soliman, San Diego, CA (US)

(73) Assignee: QUALCOMM Incoporated, San Diego, CA (US)

(21) Appl. No.: 13/692,941

(22) Filed: Dec. 3, 2012

Related U.S. Application Data
(60) Provisional application No. 61/610,306, filed on Mar. 13, 2012.

(51) Int. Cl. H04W 84/10

(52) U.S. Cl. CPC H04W 84/10
USPC 455/446

(57) ABSTRACT

Disclosed are methods, systems, apparatus, devices, products, and other implementations, including a method that includes identifying at least one neighbor small-area cell of a first small-area cell, exchanging information between the first small-area cell and the identified at least one neighbor small-area cell, the information including neighbor information for the first small-area cell and for the at least one neighbor small-area cell, and automatically configuring the first small-area cell and the at least one neighbor small-area cell for communication with a user equipment based, at least in part, on the information exchanged between the first and the at least one neighbor small-area cells.

### RELATED APPLICATIONS

The present Application for Patent claims the benefit of and priority to U.S. Provisional Application No. 61/610,306, filed Mar. 13, 2012, and entitled “APPARATUS, METHOD, AND SYSTEM FOR NEIGHBOR DISCOVERY AND MOBILITY MANAGEMENT IN A HETEROGENEOUS WIRELESS NETWORK,” which is assigned to the assignee hereof, and expressly incorporated herein by reference.

### BACKGROUND

The present disclosure is directed generally to wireless communication systems, and more particularly to communication between small cells, and mobility between small cells in heterogeneous networks.

Wireless communication networks are widely deployed to provide various communication services such as telephony, video, data, messaging, broadcasts, and so on. Such networks, which are usually multiple access networks, support communications for multiple users by sharing the available network resources.

Recently, heterogeneous networks have been an area of intense interest due to their promise of improved wireless coverage in otherwise difficult-to-cover areas like train stations, tunnels, office buildings, and homes. A heterogeneous network includes conventional high-power macro-cells, as well as various low-power nodes (small cells) such as micro-cells, pico-cells, and femto-cells, with varying capacities, coverage areas, and power capabilities.

As the demand for mobile broadband access continues to increase, research and development continue to advance heterogeneous network technology not only to meet the growing demand for mobile broadband access, but to advance and enhance the user experience with mobile communications.

### SUMMARY

Disclosed herein are methods, systems, apparatus, devices, products, and other implementations, including a method that includes identifying at least one neighbor small-area cell of a first small-area cell, exchanging information between the first small-area cell and the identified at least one neighbor small-area cell, the information including neighbor information for the first small-area cell and for the at least one neighbor small-area cell, and automatically configuring the first small-area cell and the at least one neighbor small-area cell for communication with a user equipment based, at least in part, on the information exchanged between the first and the at least one neighbor small-area cells.

Embodiments of the method may include at least some of the features described in the present disclosure, including one or more of the following features.

Exchanging the information may include performing a distributed exchange of the information between the first small-area cell and the identified at least one neighbor cell without using a central server.

Automatically configuring the first small-area cell and the at least one neighbor small-area cell may include automatically configuring the first small-area cell and the at least one neighbor small-area cell prior to transmission of data traffic through one or more of the first small-area cell and the at least one neighbor small-area cell.

Automatically configuring the first small-area cell and the at least one neighbor small-area cell may include determining one or more configuration parameters for at least one of the first small-area cell and the at least one neighbor small-area cell based, at least in part, on the information exchanged between the first small-area cell and the at least one neighbor small-area cell.

Determining the one or more configuration parameters for the at least one of the first small-area cell and the at least one neighbor small-area cell may include determining the one or more configuration parameters for the at least one of first small-area cell and the at least one neighbor small-area cell to achieve optimal or near optimal joint small-area cell network configuration to enhance overall system performance.

Determining the one or more configuration parameters may include determining the one or more configuration parameters for the at least one of first small-area cell and the at least one neighbor small-area cell to reduce inter-cell interference.

Determining the one or more configuration parameters for the at least one of first small-area cell and the at least one neighbor small-area cell may include determining for a particular cell from the at least one of the first small-area cell and the at least one neighbor small-area cell one or more parameters including one or more of, for example, transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, and/or neighbor cell list for the particular cell.

The cell reselection parameters for the particular cell may include one or more of, for example, threshold to determine whether the corresponding cell is suitable for camping, cell reselection threshold value, cell reselection hysteresis value, cell reselection timer value, and/or maximum uplink transmit power allowed for the particular cell.

Automatically configuring the first small-area cell and the at least one neighbor small-area cell for communication with the user equipment may include automatically configuring the first small-area cell and the at least one neighbor small-area cell for communication with the user equipment to cause adaptive cluster formation based, at least in part, on the information exchanged between the first and the at least one neighbor small-area cells.

Exchanging the information may include exchanging the information via a communication link comprising one or more of, for example, an out-of-band link, or a backhaul link.

The exchanged information may further include primary scrambling code (PSC) for at least one of the first small-area cell and the identified at least one neighbor small-area cell. Another PSC for another of the first small-area cell and the identified at least one neighbor small-area cell may be determined based on the PSC in the exchanged information.

The neighbor information may include first order neighbors information for each of the first small-area cell and the at least one neighbor small-area cell. The method may further include generating at one of the first small-area cell and the at least one neighbor small-area cell second order neighbor information based on the first order neighbors information for another of the first small-area cell and the at least one neighbor small-area cell.

At least one of first small-area cell and the at least one neighbor small-area cell may include a femtocell access point.

The method may further include selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

Selecting the one or more of the first small-area cell and the at least one neighbor small-area cell may include selecting the one or more of the first small-area cell and the at least one neighbor small-area cell based on one or more of, for example, air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, and/or backhaul connectivity speed for each of the first small-area cell and the at least one neighbor small-area cell.

Selecting the one or more the first small-area cell and the at least one neighbor small-area cell may include computing for each of the first small-area cell and the at least one neighbor small-area cell a corresponding selection metric according to a relationship of min{(1−fbuᵢ)*fbᵢ, (1−fauᵢ)*faᵢ}, where fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell, and selecting one of the first small-area cell and the at least one neighbor small-area cell associated with a maximum computed selection metric.

In some variations, a mobile device is disclosed. The device includes one or more transceivers, one or more processors, and storage media. The storage media includes computer instructions that, when executed on the one or more processors, cause operations including identifying at least one neighbor small-area cell of a first small-area cell, exchanging information between the first small-area cell and the identified at least one neighbor small-area cell, the information including neighbor information for the first small-area cell and for the at least one neighbor small-area cell, and automatically configuring the first small-area cell and the at least one neighbor small-area cell for communication with a user equipment based, at least in part, on the information exchanged between the first and the at least one neighbor small-area cells.

Embodiments of the device may include at least some of the features described in the present disclosure, including at least some of the features described above in relation to the method.

In some variations, an apparatus is disclosed. The apparatus includes means for identifying at least one neighbor small-area cell of a first small-area cell, means for exchanging information between the first small-area cell and the identified at least one neighbor small-area cell, the information including neighbor information for the first small-area cell and for the at least one neighbor small-area cell, and means for automatically configuring the first small-area cell and the at least one neighbor small-area cell for communication with a user equipment based, at least in part, on the information exchanged between the first and the at least one neighbor small-area cells.

Embodiments of the apparatus may include at least some of the features described in the present disclosure, including at least some of the features described above in relation to the method and the device, as well as one or more of the following features.

The means for automatically configuring the first small-area cell and the at least one neighbor small-area cell may include means for determining one or more configuration parameters for at least one of the first small-area cell and the at least one neighbor small-area cell based, at least in part, on the information exchanged between the first small-area cell and the at least one neighbor small-area cell.

The means for determining the one or more configuration parameters for the at least one of first small-area cell and the at least one neighbor small-area cell may include means for determining for a particular cell from the at least one of the first small-area cell and the at least one neighbor small-area cell one or more parameters including one or more of, for example, transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, and/or neighbor cell list for the particular cell.

The means for automatically configuring the first small-area cell and the at least one neighbor small-area cell for communication with the user equipment may include means for automatically configuring the first small-area cell and the at least one neighbor small-area cell for communication with the user equipment to cause adaptive cluster formation based, at least in part, on the information exchanged between the first and the at least one neighbor small-area cells.

The means for exchanging the information may include means for exchanging the information via a communication link comprising one or more of, for example, an out-of-band link, and/or a backhaul link.

The neighbor information may include first order neighbors information for each of the first small-area cell and the at least one neighbor small-area cell, and the apparatus further includes means for generating at one of the first small-area cell and the at least one neighbor small-area cell second order neighbor information based on the first order neighbors information for another of the first small-area cell and the at least one neighbor small-area cell.

The apparatus may further include means for selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

The means for selecting the one or more of the first small-area cell and the at least one neighbor small-area cell may include means for selecting the one or more of the first small-area cell and the at least one neighbor small-area cell based on one or more of, for example, air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, and/or backhaul connectivity speed for each of the first small-area cell and the at least one neighbor small-area cell.

The means for selecting the one or more the first small-area cell and the at least one neighbor small-area cell may include means for computing for each of the first small-area cell and the at least one neighbor small-area cell a corresponding selection metric according to a relationship of min{(1−fbuᵢ)*fbᵢ, (1−fauᵢ)*faᵢ}, where fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell, and means for selecting one of the first small-area cell and the at least one neighbor small-area cell associated with a maximum computed selection metric.

In some variations, a non-transitory processor readable media is disclosed. The processor readable media is programmed with a set of instructions executable on a processor that, when executed, cause operations that includes identifying at least one neighbor small-area cell of a first small-area cell, exchanging information between the first small-area cell and the identified at least one neighbor small-area cell, the information including neighbor information for the first small-area cell and for the at least one neighbor small-area cell, and automatically configuring the first small-area cell and the at least one neighbor small-area cell for communication with a user equipment based, at least in part, on the information exchanged between the first and the at least one neighbor small-area cells.

Embodiments of the processor readable media may include at least some of the features described in the present disclosure, including at least some of the features described above in relation to the method, the device, and the apparatus.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, is meant to encompass variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, is also meant to encompass variations of ±20% or ±10%, ±5%, or +0.1% from the specified value, as such variations are appropriate to in the context of the systems, devices, circuits, methods, and other implementations described herein.

As used herein, including in the claims, “or” and “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” may also include AA, AAB, AAA, BB, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Unless defined otherwise, all technical and scientific terms used herein have the same meaning as commonly understood by one of ordinary skill in the art to which this disclosure pertains.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a block diagram illustrating an example of a hardware implementation for an apparatus or device employing a processing system.

FIG. 2 is a diagram illustrating an example of a radio protocol architecture for user and control plane.

FIG. 3A is a diagram illustrating an example of a telecommunications system.

FIG. 3B is a diagram of another example of a telecommunication system.

FIG. 4 is a diagram illustrating an example of a communication network.

FIG. 5 is a block diagram illustrating an example of a Node B (e.g., small-area cell) in communication with user equipment (UE) in a telecommunications system.

FIGS. 6-8 are diagrams illustrating small-area-cell to small-area-cell communication links.

FIG. 9 is a diagram illustrating a cluster of low-power nodes.

FIG. 10 is a diagram illustrating an extended femto set.

FIG. 11 is a flowchart of an example procedure for wireless communication.

Like reference symbols in the various drawings indicate like elements.

### DETAILED DESCRIPTION

The description set forth below in connection with the appended drawings is intended as a description of various configurations and is not intended to represent the only configurations in which the concepts described herein may be practiced. The description includes details for the purpose of providing an understanding of various concepts. However, these concepts may be practiced without these specific details. In some instances, well known structures and components are shown in block diagram form in order to avoid obscuring such concepts.

Disclosed herein are methods, systems, devices, apparatus, products, and other implementations, including a method of wireless communication that includes identifying at least one neighbor small-area cell of a first small-area cell (e.g., a femto cell), exchanging information (e.g., cell information) between the first small-area cell and the identified at least one neighbor small-area cell, the information including neighbor information for the first small-area cell and for the at least one neighbor small-area cell, and automatically configuring the first small-area cell and the at least one neighbor small-area cell for communication with a user equipment (e.g., a wireless device) based, at least in part, on the information exchanged between the first and the at least one neighbor small-area cells.

In some embodiments, the neighbor information may include, for example, first order neighbor information (e.g., identity of immediate neighbors) of one of the interacting small-area cells, and the other interacting small-area cell may generate from the first order neighbor information second order neighbor information (i.e., information about neighboring cell(s) of that cell's neighbors). In some embodiments, identification of neighboring cell, and the exchange of information between neighboring cells may be performed through backhaul or out-of-band communication links (e.g., communication links based on communication technologies/protocols such as WiFi, Bluetooth, etc.) In such embodiments, transceiver devices (such as femto-cell access points) may communicate with each other over backhaul/out-of-band links to exchange data germane to configuring a small-area cell network to communicate with a mobile device (also referred to as a user equipment, or UE). In other words, the information exchanged between the cells may be used to configure the wireless communication functionality of the small-area cells with wireless devices (e.g., configure the cells to control, for example, their transmission powers, primary scrambling codes used, etc.) Mobile devices (also referred to as mobile station or wireless devcies/stations) may then communicate with one or more transceiver devices in the configured small-area cell network over the small-area cell primary links (e.g., based on cellular technologies, such as CDMA, WiMax, etc.)

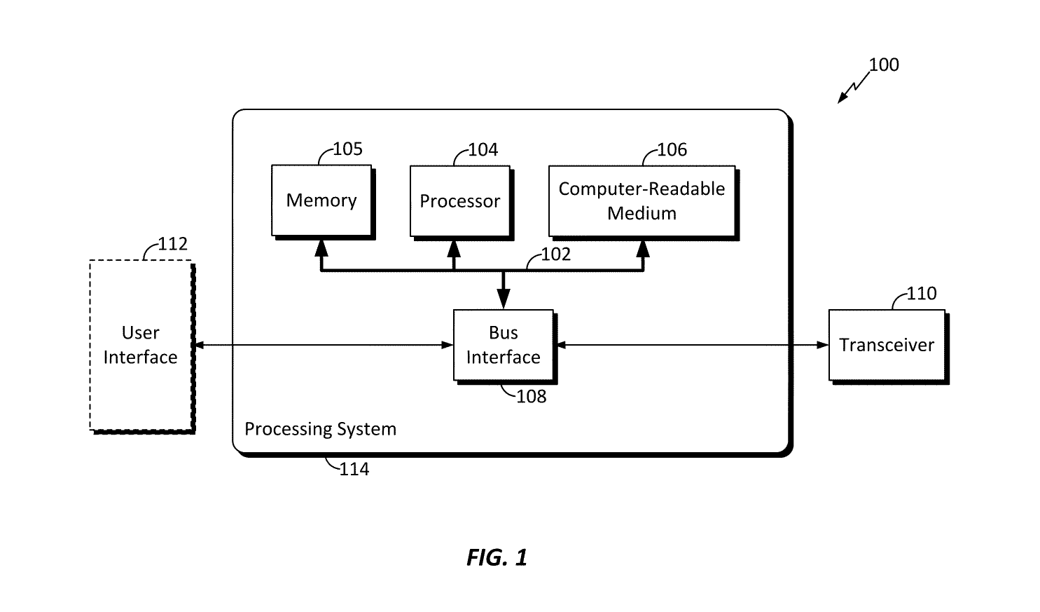

FIG. 1 is a schematic diagram illustrating an example of a hardware implementation for a communication apparatus 100, employing a processing system 114, which may be similar to hardware used in conjunction with transceiver devices, devices communication with transceiver device, etc. One or more of the devices described herein, including, transceiver devices, mobile devices, server, etc., may be implemented using hardware that includes a processing system, such as the processing system 114, that includes one or more processors 104. Examples of the processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In the example of FIG. 1, the processing system 114 may be implemented with a bus architecture, represented generally by a bus 102. The bus 102 may include any number of interconnecting buses and bridges depending on the specific application of the processing system 114 and the overall implementation constraints. The bus 102 links various modules/units/circuits of the processing system 114, including one or more processors (represented generally by the processor 104), a memory 105, and computer-readable media (represented generally by computer-readable medium 106). The bus 102 may also link various other modules/units/circuits such as clock (timing) resources, peripheral devices, voltage regulators, power management circuits, etc. A bus interface 108 provides an interface between the bus 102 and a transceiver 110. The transceiver 110 is configured to communicate with various other apparatus (e.g., other processing systems, such as the example processing system 114, which may be configured to perform various functionalities, such as performing a transceiver device's functionality, a mobile device's functionality, etc.) over a transmission medium. Depending upon the nature of the apparatus, a user interface 112 (e.g., keypad, display, speaker, microphone, joystick) may also be provided.

In some embodiments, the processor 104 is configured to manage the bus 102 and perform general processing, including the execution of software stored on the computer-readable medium 106. The software, when executed by the processor 104, causes the processing system 114 to perform the various functions described herein for any particular apparatus. The computer-readable medium 106 may also be used for storing data that is processed/manipulated by the processor 104 when executing software.

The one or more processors 104 in the processing system 114 may execute software. Software refers to instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, may be external to the processing system 114, or distributed across multiple entities including the processing system 114. The computer-readable medium 106 may be embodied in a computer program product. By way of example, a computer program product may include a computer-readable medium in packaging materials.

The disclosure provided herein may be implemented across a broad variety of telecommunication systems, network architectures, and communication standards. In any particular wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between a mobile user equipment (UE) and the core network, and may include circuit switched and packet switched protocols. The AS provides the lower layers, for signaling between the access network and the UE, and may include a user plane and a control plane. Here, the user plane (data plane) carries user traffic, while the control plane carries control information (i.e., signaling).

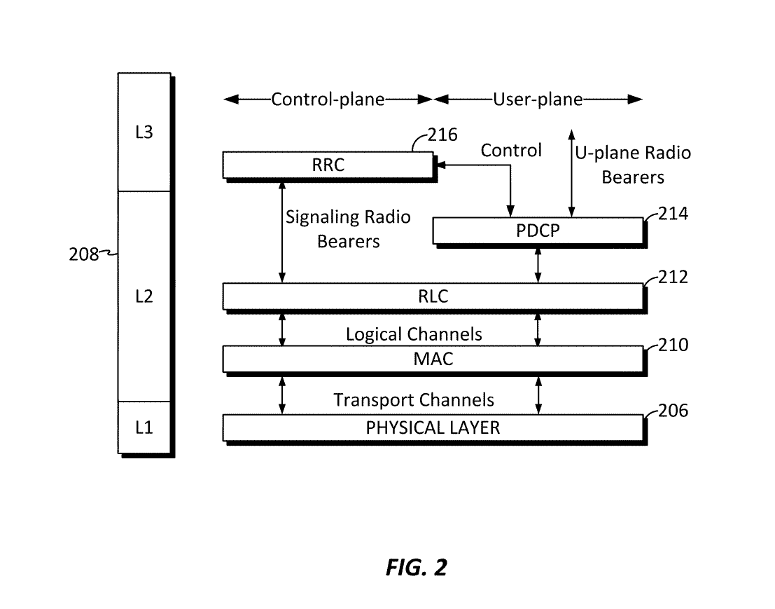

With reference to FIG. 2, an example embodiment of an AS is shown with three layers: Layer 1, Layer 2, and Layer 3. Layer 1 (L1) is the lowest layer and implements various physical layer signal processing functions. Layer 1 will be referred to herein as the physical layer 206. The data link layer, also referred to as Layer 2 (L2) 208, is above the physical layer 206 and is responsible for the link between the UE 210 and a Node B over the physical layer 206.

At Layer 3 (L3), an RRC layer 216 handles the control plane signaling between the UE 210 and the Node B. RRC layer 216 includes a number of functional entities for routing higher layer messages, handling broadcasting and paging functions, establishing and configuring radio bearers, etc.

In the illustrated diagram, the L2 layer 208 is split into sub-layers. In the control plane, the L2 layer 208 includes two sub-layers: a medium access control (MAC) sublayer 210 and a radio link control (RLC) sublayer 212. In the user plane, the L2 layer 208 additionally includes a packet data convergence protocol (PDCP) sublayer 214. Although not shown, the UE may have several upper layers above the L2 layer 208, including a network layer (e.g., IP layer)

The PDCP sublayer 214 provides multiplexing functionality between different radio bearers and logical channels. The PDCP sublayer 214 also provides header compression for upper layer data packets to reduce radio transmission overhead, security by ciphering the data packets, and handover support for UEs between Node B's.

The RLC sublayer 212 generally supports an acknowledged mode (AM) (where an acknowledgment and re-transmission process may be used for error correction), an unacknowledged mode (UM), and a transparent mode (TM) for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 210 provides multiplexing between logical and transport channels. The MAC sublayer 210 is also responsible for allocating the various radio resources (e.g., resource blocks) in one cell among the UE's. The MAC sublayer 210 is also responsible for HARQ operations for High Speed Packet Access (HSPA).

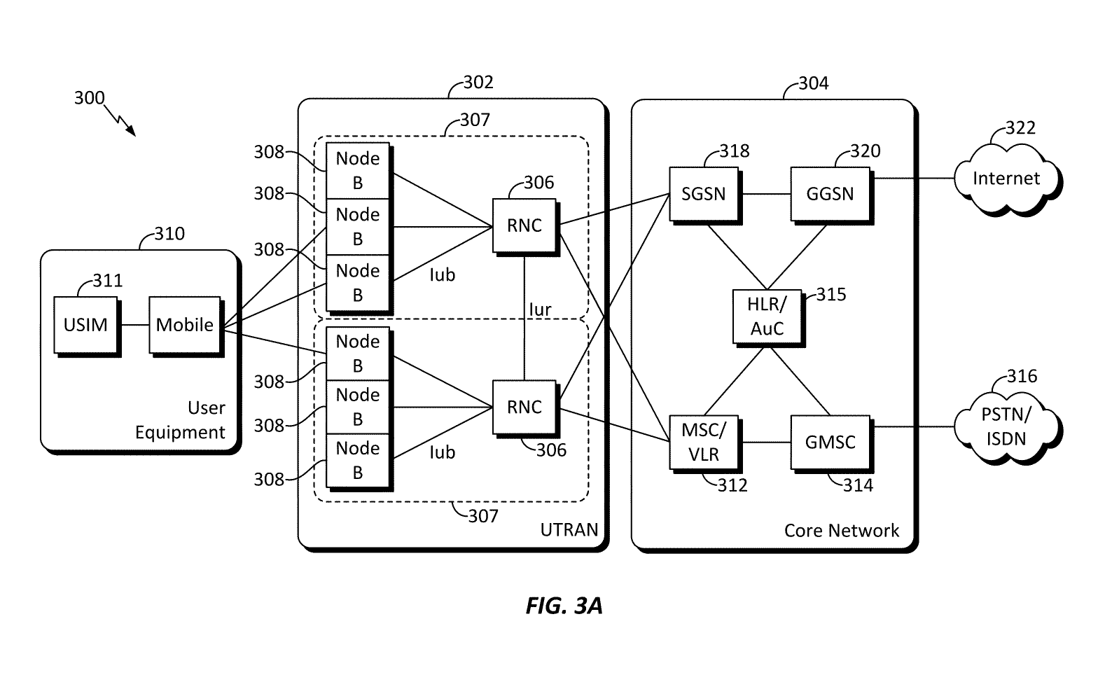

Referring now to FIG. 3A, a schematic diagram of an example embodiment of a Universal Mobile Telecommunications System (UMTS) network 300 is shown. The UMTS network 300 includes three interacting domains: a core network 304, a radio access network (RAN) (e.g., the UMTS Terrestrial Radio Access Network (UTRAN)) 302, and a user equipment (UE) 310. Among several options available for a UTRAN 302, in this example, the illustrated UTRAN 302 may employ a W-CDMA air interface for enabling various wireless services including telephony, video, data, messaging, broadcasts, and/or other services. The UTRAN 302 may include a plurality of Radio Network Subsystems (RNSs) such as an RNS 307, each controlled by a respective Radio Network Controller (RNC) such as an RNC 306. Here, the UTRAN 302 may include any number of RNCs 306 and RNSs 307 in addition to the illustrated RNCs 306 and RNSs 307. The RNC 306 is an apparatus responsible for, among other things, assigning, reconfiguring, and releasing radio resources within the RNS 307. The RNC 306 may be interconnected to other RNCs (not shown) in the UTRAN 302 through various types of interfaces such as a direct physical connection, a virtual network, or the like using any suitable transport network.

The geographic region covered by the RNS 307 may be divided into a number of cells, with a radio transceiver apparatus serving each cell. A radio transceiver apparatus is commonly referred to as a Node B in UMTS applications, but may also be referred to as a base station (BS), a base transceiver station (BTS), a radio base station, a radio transceiver, a transceiver function, a basic service set (BSS), an extended service set (ESS), an access point (AP), or some other suitable terminology. For clarity, three Node B's 308 are shown in each RNS 307; however, the RNSs 307 may include any number of wireless Node B's. As will be described in greater details below, in some embodiments, the Nodes B may include small-area cells (also referred to as Home Node B, or HNB) implemented, for example, using low-power transceivers such as femto cells. The small-area cells may be configured to communicate with each other via backhaul or out-band-links to exchange information such as neighboring information. Based on the exchanged information, the small area cells (corresponding, for example, to the Node B's 308 depicted in FIG. 3) may automatically configure themselves for communication with one or more user equipment so as to enable enhanced cooperation between multiple (e.g., numerous) small cell networks operating in geographic proximity of each other and mitigating inter small cell interference.

The Node B's 308 provide wireless access points to a core network 304 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a tablet device, a satellite radio, a global positioning system (GPS) device, a multimedia device, a video device, a digital audio player (e.g., MP3 player), a camera, a game console, or any other similar functioning device. As noted, the mobile apparatus is commonly referred to as user equipment (UE) in UMTS applications, but may also be referred to as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 310 may further include a universal subscriber identity module (USIM) 311, which contains a user's subscription information to a network. For illustrative purposes, one UE 310 is shown in communication with a number of the Node B's 308, but any number of UE's may communicate with the radio access network 302. The downlink (DL), also called the forward link, refers to the communication link from a Node B 308 to a UE 310 and the uplink (UL), also called the reverse link, refers to the communication link from a UE 310 to a Node B 308.

In some embodiments, the core network 304 can interface with one or more access networks, such as the UTRAN 302. As shown, the core network 304 is a UMTS core network. However, the systems and methods presented throughout this disclosure may be implemented in a RAN, or other suitable access network, to provide UE's with access to types of core networks other than UMTS networks.

The illustrated UMTS core network 304 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In some embodiments, the core network 304 supports circuit-switched services with a MSC 312 and a GMSC 314. In some applications, the GMSC 314 may be referred to as a media gateway (MGW). One or more RNCs, such as the RNC 306, may be connected to the MSC 312. The MSC 312 is an apparatus that controls call setup, call routing, and UE mobility functions. The MSC 312 also includes a visitor location register (VLR) that contains subscriber-related information for the duration that a UE is in the coverage area of the MSC 312. The GMSC 314 provides a gateway through the MSC 312 for the UE's to access a circuit-switched network 316. The GMSC 314 includes a home location register (HLR) 315 containing subscriber data, such as the data reflecting the details of the services to which a particular user has subscribed. The HLR is also associated with an authentication center (AuC) that contains subscriber-specific authentication data. When a call is received for a particular UE, the GMSC 314 queries the HLR 315 to determine the UE's location and forwards the call to the particular MSC serving that location.

In some implementations, the illustrated core network 304 may be configured to support packet-switched data services with a serving GPRS support node (SGSN) 318 and a gateway GPRS support node (GGSN) 320. General Packet Radio Service (GPRS) is generally implemented to provide packet-data services at speeds higher than those available with standard circuit-switched data services. The GGSN 320 provides a connection for the UTRAN 302 to a packet-based network 322. The packet-based network 322 may include the Internet, a private data network, or some other suitable packet-based network. One function of the GGSN 320 is to provide the UE's 310 with packet-based network connectivity. Data packets may be transferred between the GGSN 320 and the UEs 310 through the SGSN 318, which performs primarily the same functions in the packet-based domain as the MSC 312 performs in the circuit-switched domain.

In some implementations, the UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 302 is based on such DS-CDMA technology and additionally calls for a frequency division duplexing (FDD). FDD uses a different carrier frequency for the uplink (UL) and downlink (DL) between a Node B 308 and a UE 310. Another air interface for UMTS that utilizes DS-CDMA, and uses time division duplexing (TDD), is the TD-SCDMA air interface.

As noted, in some embodiments, the cells communicating with mobile devices may include Home Node B's (HNB's) such as femotcells or other types of small-area cells. Thus, with reference to FIG. 3B, a schematic diagram of an example embodiment of a communication network 350 that includes one or more HNB's 358 is shown. The network 350 includes a core network 354 which may be similar to the core network 304 of FIG. 3B, and one or more user equipment (UE) 360, which may be similar to the UE 310 depicted and described in relation to FIG. 3A. As shown, in some implementations, the HNB's communicate with the core network via one or more HNB gateways, referred to as HNB-GW, which direct HNB data traffic to and from the core network 354 via, for example, standard lu-cs and lu-ps interfaces.

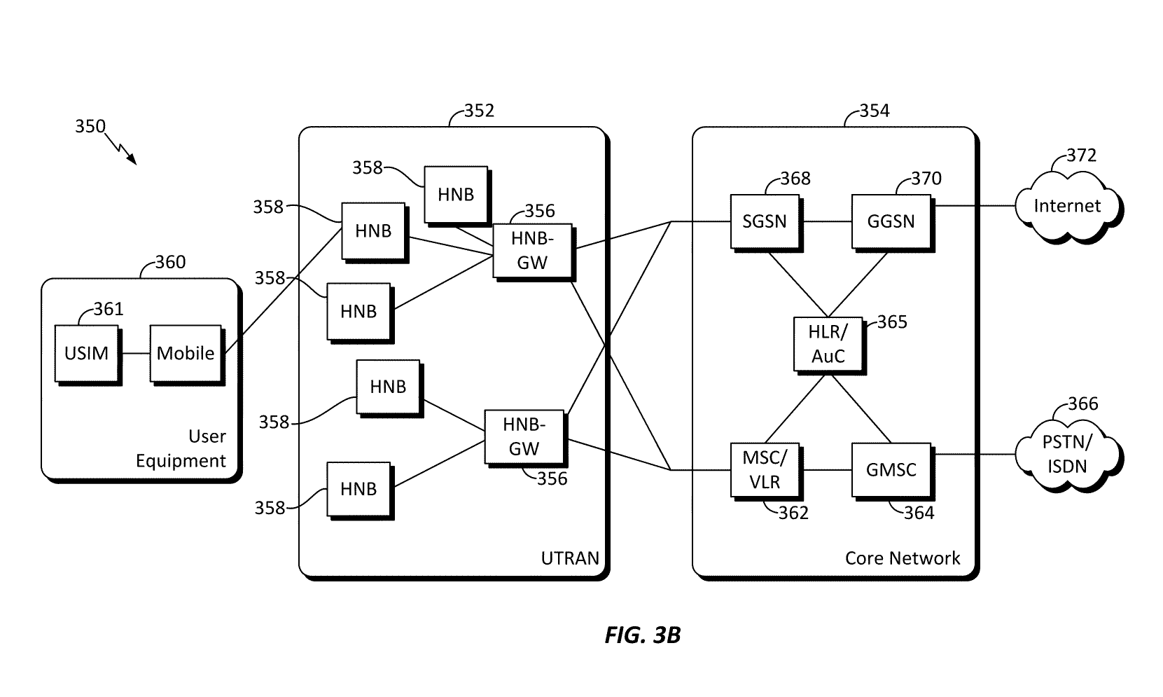

Referring now to FIG. 4, a simplified schematic illustration of a RAN 400 (which may be similar to the RAN 302 depicted in FIG. 3) in a UTRAN architecture is illustrated. The system includes multiple cellular regions (cells), including cells 402, 404, and 406, each of which may include one or more sectors. Cells may be defined geographically (e.g., by coverage area) and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404, which is served by a Node B (access point) 444 may utilize a first scrambling code, and cell 402, which is served by a Node B 442, may avoid interfering with implementation/operation of the cell 404 by utilizing a second scrambling code.

In a cell that is divided into sectors, the multiple sectors within a cell can be formed by groups of antennas with each antenna responsible for communication with UE's in a portion of the cell. For example, in cell 402, antenna groups 412, 414, and 416 may each correspond to a different sector. In cell 404, antenna groups 418, 420, and 422 may each correspond to a different sector. In cell 406, antenna groups 424, 426, and 428 may each correspond to a different sector.

As noted, the cells 402, 404, and 406 may communicate with one or more UE's. For example, UE's 430 and 432 may be in communication with Node B 442 (which, as noted, may be a small-area cell that was configured in accordance with the methods and procedures described herein), UE's 434 and 436 may be in communication with Node B 444, and UE's 438 and 440 may be in communication with Node B 446. Here, each Node B 442, 444, and 446 may be configured to provide an access point to a core network, such as the core network 304 of FIG. 3, for all the UE's 430, 432, 434, 436, 438, and 440 in the respective cells 402, 404, and 406.

During a call with a source cell, or at any other time, the UE 436, for example, may monitor various parameters of the source cell as well as various parameters of neighboring cells. Further, depending on the quality of these parameters, the UE 436 may maintain communication with one or more of the neighboring cells. During this time, the UE 436 may maintain an Active Set, which is a list of cells to which the UE 436 is, or can be, connected (e.g., the UTRAN cells that are currently assigning a downlink dedicated physical channel DPCH, or fractional downlink dedicated physical channel F-DPCH, to the UE 436 may constitute the Active Set).

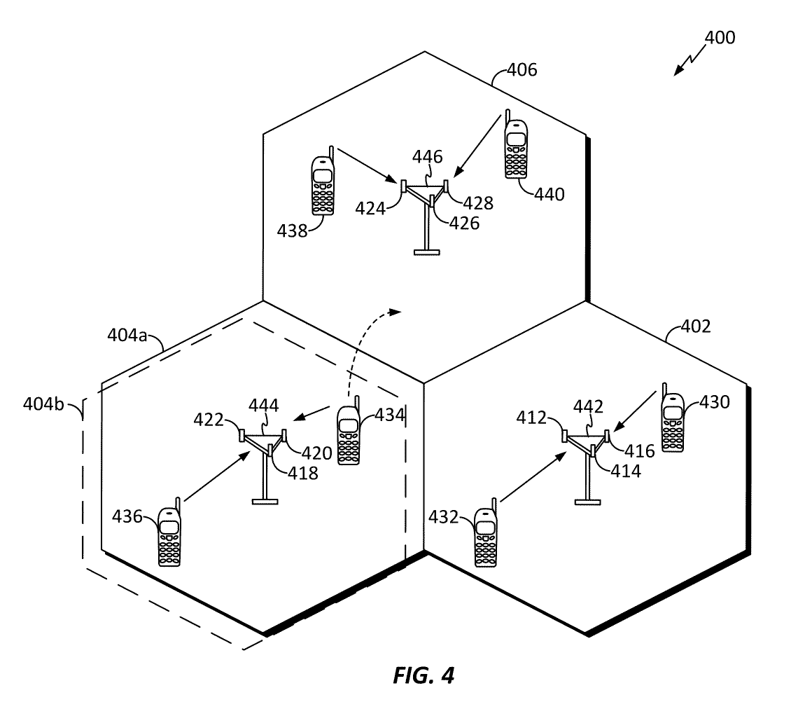

With reference now to FIG. 5, a block diagram of an example system including a Node B 510 in communication with an example UE 550 is shown. The Node B 510 may be similar to any of the Node B's 308 shown in FIG. 3, and the UE 550 may be similar to the UE 310 shown in FIG. 3. The Node B 510 may include a small-area cell (e.g., a femto-cell) with functionality similar to that discussed in greater detail below. In a downlink communication from the Node B 510 to the UE 550, a transmit processor 520 may receive data from a data source 512 and control signals from a controller/processor 540. The transmit processor 520 is configured to perform various signal processing functions for/on the data and control signals, as well as for/on reference signals (e.g., pilot signals). For example, the transmit processor 520 may be configured to provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

The UE 550 includes a receiver 554 to receive downlink transmissions through an antenna 552 and to process the transmissions to recover the information modulated onto carriers. The information recovered by the receiver 554 is provided to a receive frame processor 560, which is configured to, among other functions, parse each frame, and provide information from the frames to a channel processor 594, and provides the data, control, and reference signals to a receive processor 570. The receive processor 570 is configured to perform the inverse of the processing performed by the transmit processor 520 in the Node B 510. More specifically, the receive processor 570 can descramble and de-spread the symbols, and determine the most likely signal constellation points transmitted by the Node B 510 based on the modulation scheme. These soft decisions may be based on channel estimates computed by the channel processor 594. The soft decisions are then decoded and de-interleaved to recover the data, control, and reference signals. CRC codes may be checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In uplink communication, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which can parse each frame, and provide information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor 538, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

In a heterogeneous wireless network, multiple kinds of access points may provide wireless service to a UE, including, for example, high-power nodes (frequently referred to as macro-cells) and low-power nodes. The low-power node can be any one of several examples of low-power nodes. Low power nodes are also called small cells, or small-area cells (or small-area access points) because of their generally smaller coverage provided compared to macro cells. For example, a femto-cell, sometimes called a home Node B (HNB), home eNode B (HeNB), a Femtocell Access Point (FAP), or any other suitable name, is a small base station or Node B typically configured for use in a home or office, or some other relatively small geographical area. The femto-cell may typically utilize a high-speed Internet connection, such as a cable or DSL connection for its backhaul connection to the core network. A pico-cell (or micro-cell) is a relatively small and low-cost base station typically deployed to extend coverage from that available from a macro-cell deployment, e.g., into buildings, malls, train stations, etc., where coverage from macro-cells may otherwise be lacking. Low-power nodes have recently been deployed in rapidly increasing numbers with an aim to achieve cell splitting gain. That is, because there is a limited amount of spectrum available for deploying additional carrier frequencies within the same region, cell splitting can help to increase a network's capacity.

In some implementations, clusters or groups of small-area cells (nodes) may be configured with small-area-cell-to-small-area-cell communication capabilities, and various other adaptations to provide for joint configuration of small-area-cell parameters to control their wireless communication performance with UE's, and for enhanced mobility of UE's within the cluster. Generally, small cells communicating with each other do not form explicit networks (except to provide for seamless mobility within small cells). As noted, in some embodiments, small cells are configured to detect one or more neighboring small cells, exchanges information (including some parameters) to enable a joint small cell configuration. Each small cell may then serve the UEs associated to it. Subsequent to the exchange of information between small cells to facilitate joint small cell configuration, additional communication between small cells may occur when some parameters change for one or more of the small cells, and the joint configuration enabled through the cell-to-cell communication requires updating.

The term “small-area-cell-to-small-area-cell communication” encompasses communication in any group of low-power nodes in a wireless communication network, e.g., pico-cells, femto-cells, etc., or between different categories of small cells e.g. pico-femto, etc., or, in some examples, may apply to macro-cells as well. Cooperation between neighboring small-area cells/nodes, such as femto-cells, may be utilized to, in some embodiments, obtain an enhanced topology map of the neighboring small cells of interest, to facilitate enhanced transmit power calibration of small cells, avoid choosing the same primary scrambling code (PSC) between neighboring small cells (and thus avoid PSC collision), enable enhanced small cell selection by the UEs and enable adaptive network/cluster formation with the neighboring small cells to provide for contiguous RF coverage and seamless mobility for UEs within the coverage area of the cluster.

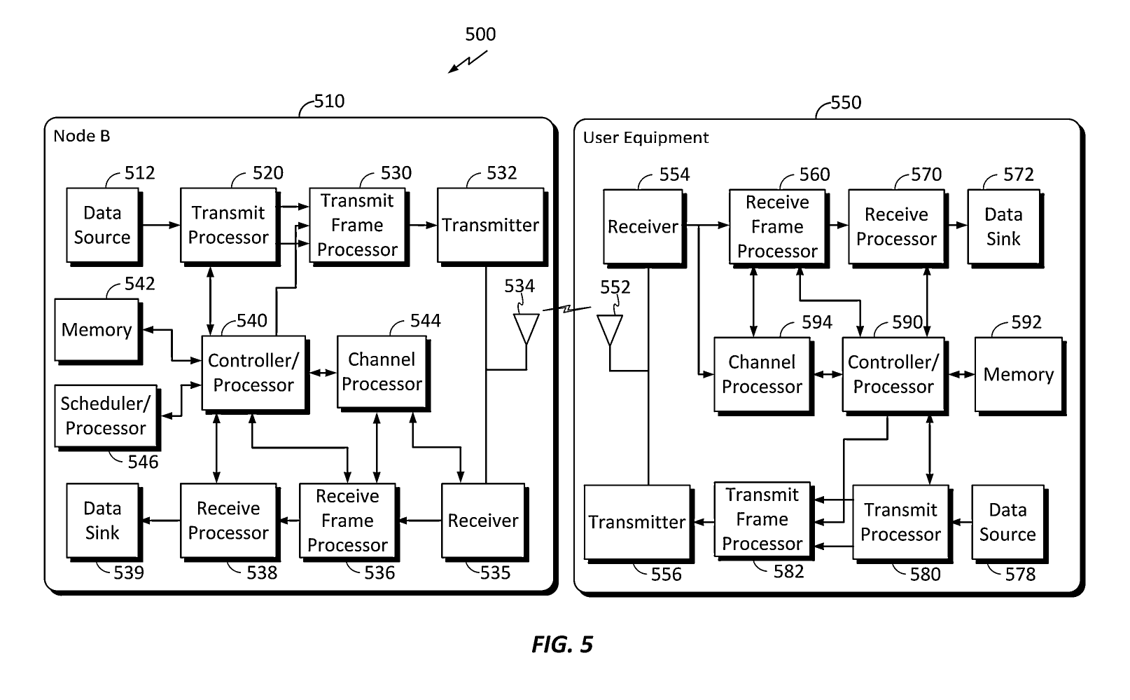

Thus, with reference to FIG. 6-8, different small-area cell network configurations, that include a first small-area cell (e.g., a small-area cell 610 in FIG. 6) and at least one neighbor small-area cell (e.g., cell 620 in FIG. 6) are shown. In the shown example embodiments of the networks of FIGS. 6-8, a first small-area cell (such as the cell 610 of FIG. 6) is adapted to identify at least one neighbor small-area cell (such as the cell 620 in FIG. 6), to exchange information (e.g., cell information) with at least one neighbor information (e.g., neighbor information to identify the two cells' respective neighbors) via a communication link established between the two cells, and to be automatically configured based, at least in part, on the information exchanged between the first and the at least one neighbor small-area cells. Although the example embodiments of FIGS. 6-8 show only two small-area-cells, small-area cell networks may have any number of small-area cells, with at least one of those cells being adapted to perform automatic configuration (e.g., of the cells' wireless communication functionality) based on information exchanged with identified neighboring cells.

More particularly, FIG. 6 is a diagram of a network 600 in which a backhaul-based communication link is established between the first small-area cell 610 and its neighbor small-area cell 620. Such a backhaul link may be established via a communication network that the first cell and its neighbor cell are connected to. As shown in FIG. 6, in some embodiments, the small-area cells 610 and 620 (which may include, for example, femto access points (FAP)) are each coupled to respective broadband modems 612 and 622 utilizing wired connection, e.g. Ethernet, thus forming, for example, a Femto-WiFi system. In some embodiments, the small-area cells and the WiFi access point may be integrated. The small-area cells may each be associated with, for example, an identification value, such as a femto ID, a WiFi ID, an IP address corresponding to the backhaul connection, a primary scrambling code (PSC) for a Wireless Wide Area Network (WWAN) air interface, etc. The broadband modems 612 and 622, which may include one or more of, for example, a cable modem, a DSL modem, or any suitable modem, may be suitably coupled to a network 630 such as the Internet (or any other type of network, including packet-based network, non-packet-based network, etc.), to thus enable establishment of a communication link to a Home Node B Gateway (HNB-GW) 640. The HNB-GW is a conventional network entity that generally behaves like a radio network controller RNC in a UMTS network.

As noted, in some embodiments, at least some of the small-area cells in a particular geographic area may be configured to communicate with neighbor small-area access cells. For example, as illustrated in FIG. 6, a small-area cell, such as the cells 610 and/or 620 may each include a network listen module (NLM) to identify neighbor cells/nodes and to determine information about the neighbor small cells/nodes. In some implementations, the NLM may be configured to sniff/listen to the system information messages broadcast by a neighboring cell on the same or different frequency/channel on which the small cell is operating in order to, for example, identify it and gather aiding information related to that neighboring small cell like PSC. Thus, the NLM in the small cell acts like a virtual UE1. Here, the first small-area cell 610, for example, may scan its proximity to obtain information about neighboring cells (e.g., femto-cells, macro-cells, etc.) The small cell's NLM, for example, can enable collection of such information as the PSC's of neighboring cells within range. Furthermore, in some implementations, the small-area cell(s) may include an out-of-band (OOB) interface to enable the cell to obtain OOB identifiers of neighbor cells that are configured to communicate through that type of an OOB interface. With information obtained by the first small-area cell, the cell may contact a server, such as a RADIUS server (e.g., hosted at the HNB-GW), and obtain the IP address of the neighboring cells. This information, once obtained, may be stored at the small cell so that such information gathering functionality does not need to be repeated.

Once the IP address of neighboring small-area cells are known, a link may be set up between the first cell and at least one of its neighboring cells (e.g., the cell 620 in the example embodiment of FIG. 6). A suitable transport layer protocol, e.g., Stream Control Transmission Protocol (SCTP) over IP, may be utilized for establishing this link. Such a link may be similar to an X2 interface standardized in an E-UTRAN (LTE) network. In some embodiments, the protocol for communicating between the cells (nodes) may be similar to the Inter Access Point Protocol (IAPP) utilized for 802.11 networks. Thus, in embodiments such as those depicted in FIG. 6, a first small-area cell is configured to identify (e.g., through a NLM unit) at least one neighbor small-area cell, and to exchange information (e.g., cell information, including neighbor information etc.) via a backhaul link (e.g., an IP-based communication link) established through a network to which the two small-area cells are connected (e.g., via a modem such as the broadband modems 612 and 622 depicted in FIG. 6).

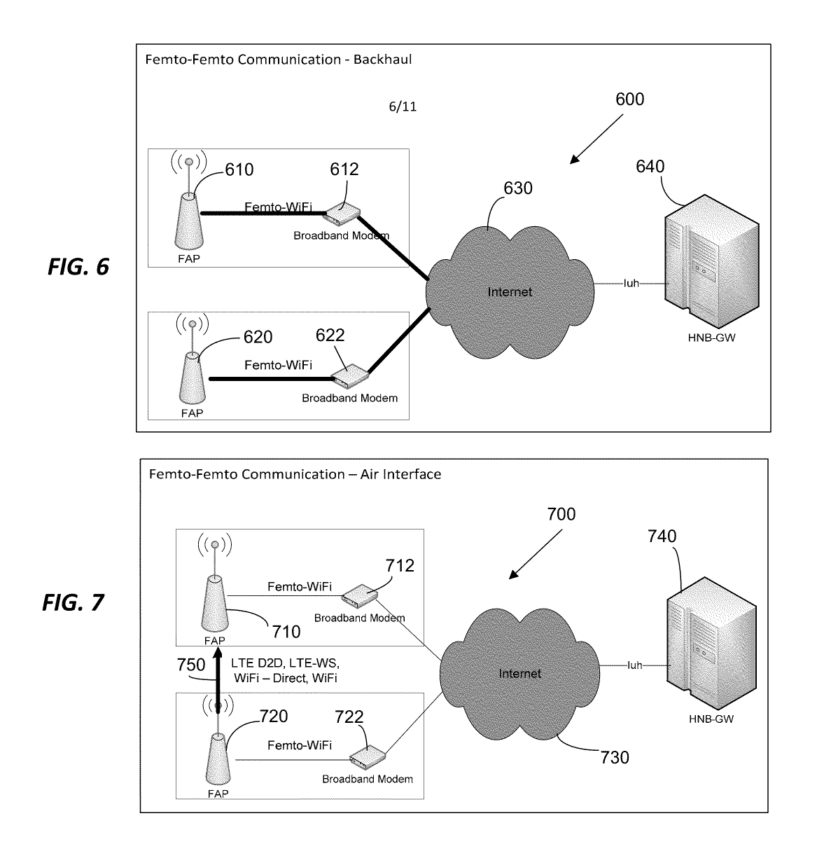

FIG. 7 is a schematic diagram illustrating communication between a first small-area cell 710 and a neighbor small-area cell 720 implemented via an in-band or out-of-band (OOB) link established between the two small-area cells. For example, in implementations in which the small-area cells can communicate via in-band links, e.g., E-UTRAN (LTE)-based communication, the small-area cells may be configured to implement LTE Device to Device (D2D) (also known as LTE Direct) or LTE over white space (LTE-WS) protocols to communicate with one another. Of course, any other suitable WWAN air interface protocol may be utilized for the in-band link between the low-power nodes. For out-of-band communication, WiFi, WiFi Direct, Bluetooth etc. could be used between the small cells if so equipped.

As noted, in some embodiments, the wireless air interface may be an OOB link, such as a WiFi link. In one example, a virtual STA attached to IFW-AP may connect to a neighbor IFW AP and obtain (e.g., retrieve) relevant information over the WiFi link. Additionally, and/or alternatively, a WiFi Direct protocol may be utilized between IFW APs. Here, white space, e.g., WiFi or WiFi Direct over white space, may be utilized for the link between the small-area cells, while the ISM band may be utilized for other communication. In some embodiments, Power Line Communication (PLC) or any other suitable protocol may be utilized for cell-to-cell communication (e.g., communication between one access point/node to another access point/node).

In some embodiments, a “virtual UE” may be integrated into a small-area cell (such as a femto-cell), and the “virtual UE” may be configured to connect to a neighbor small cell and establish bi-directional communication over the air interface. In such embodiments, the virtual UE can be enabled to transmit to neighboring small-area cells in the same or in a similar fashion as a conventional UE. In other words, the small-area cell may be configured to communicate with a neighboring access point (small-area cell) in a manner similar to the way a UE would communicate with an access point of the network with which it is in communication. A virtual UE may enable uplink transmission as well as downlink reception capabilities. With a virtual UE, neighboring low-power nodes can communicate with one another over their respective WWAN interface or over an OOB interface (such as WiFi.)

Thus, as shown in FIG. 7, the first small-area cell 710 may be configured to identify (e.g., using an NLM; not shown) the at least one neighbor small-area cell 720. Similar to the configurations depicted in FIG. 6, in some implementations, the small-area cells 710 and 720 may be coupled to a network (e.g., the Internet or some other public or private network) via modems, such as the broadband modems 712 and 722 (which may be similar to the modems 612 and 622 of FIG. 6). In the embodiments of FIG. 7, the small-area cells are configured to establish a communication link 750 between them via the cells' air interface, and to exchange information (e.g., cell information, including neighbor information). Based on the information exchanged via the air-interface link, which, as noted, may be an LTE 2D2 link, an LTE-WS link, a WiFi-direct, or some other out-of-band air link (e.g., based on communication protocol and/or bands other than those used for UE-to-cell communication), at least one of the first small area cell 710 and the neighbor small-area cell 720 may be automatically configured to implement an optimal (or near optimal) small-area cell network for communication with UE's.

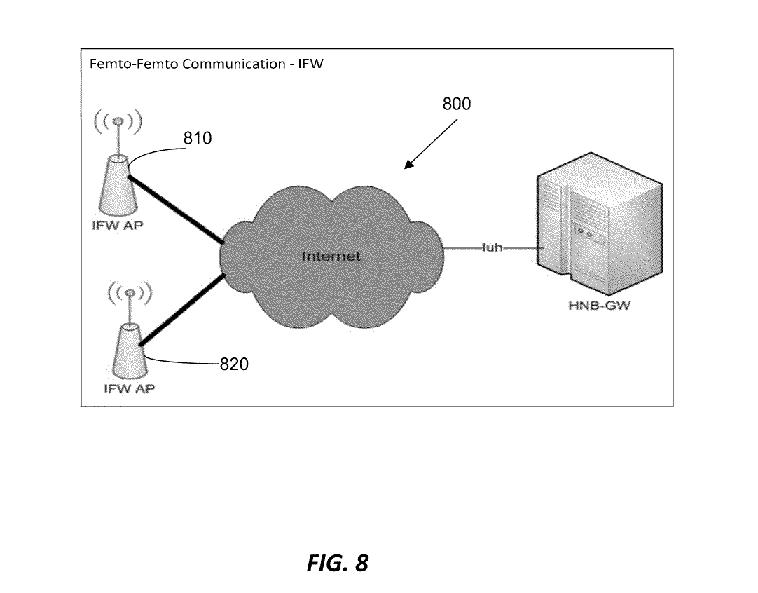

With reference now to FIG. 8, a network configuration 800 that includes small-area cells 810 and 820, which may be Integrated Femto WiFi (IFW) access points, is shown. In the embodiments of FIG. 8, the small-area cells 810 and 820 may implement, for example, IEEE 802.11f or Inter-Access Point Protocol (IAPP) to enable the cells to communicate with one another. Other suitable wired or wireless distribution systems may also be utilized in some embodiments, e.g., proprietary protocols not based on IAPP. In example implementation, neighbor detection can be over NLM or OOB link. Once a neighboring cell is detected, the detecting small cell may obtain the neighboring cell's IP address from, for example, RADIUS server, and establish a communication link with the neighboring cell using IAPP.

Information exchanged between cells through cell-to-cell communication links (e.g., femto-AP-to-femto-AP communication) can accordingly facilitate implementing an enhanced neighbor topology for small cells in a heterogeneous network.

Thus, using various types of cell-to-cell communication links between a cell and at least one of its neighbor cells, as described herein in relation to FIGS. 6-8, information is exchanged via those links, and based on that exchanged information, enhanced neighbor topology may be determined/derived. For example, a small-area cell may advertise/communicate an initial neighbor list that includes its immediate neighbor cells (i.e., small-area neighbor cells as well as other neighboring devices such as high-power nodes) that it can detect based on, for example, its network listen module. This initial list corresponds to first order neighbors of the small-area cell. In some implementations, if an OOB link is enabled, a small-area cell may augment its neighbor list with neighbor small-area cells that it can detect by utilizing, for example, its OOB interface. These neighbors may also be characterized as first order neighbors. In some embodiments, only the neighbor list containing first order neighbors are exchanged between small cells.

In some embodiments, a cell's neighbor list may be refined with assistance from neighboring small-area cells, e.g., by establishing small-area-cell-to-small-area-cell communication links and with its neighbors and exchanging information, including neighboring information, with those neighboring cells. That is, identity of the neighbors of its neighbors may be obtained by a small-area cell, with those identified neighbors of neighbors categorized as second order neighbors. In some embodiments, the neighbor cells may be ranked, e.g., according to their proximity to the first small-area cell, their location, etc. In this fashion, an improved neighbor topology can be established for a small-area cell.

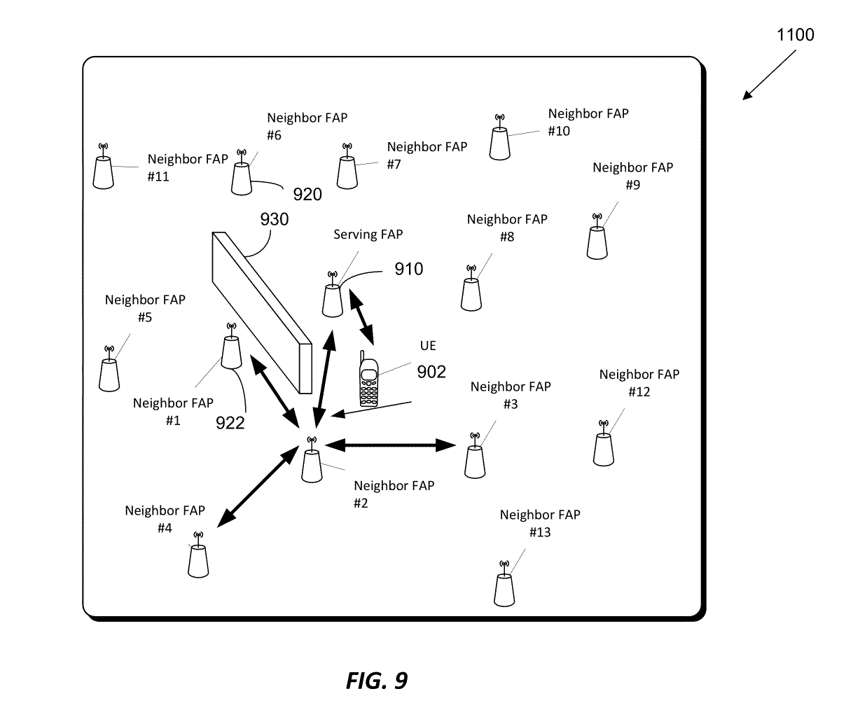

Thus, with reference to FIG. 9, a schematic diagram of an example embodiment of a cluster 900 of small-area cells, which may have been configured/constructed based on information exchanged between various small-area cells using cell-to-cell communications links (out-of-band or backhaul) is shown. As illustrated, the cluster 900 includes multiple small-area cells, which in the example of FIG. 9 may be femto access points (although different types of low-power, small-area cells may be used in conjunctions with, or instead of, any of the nodes illustrated in FIG. 9). In the illustration of FIG. 9, a UE 902 is in communication with a serving FAP 910. Here, the serving node may have a neighbor list including neighbors obtained through the cell's network listen module (NLM), specifically:

{FAP #7, FAP #8, FAP #2, FAP #3}

This neighbor list at the serving node 910 may be refined to include neighbors obtained by way of an out-of-band detection unit (implemented through the cell's out-of-band interface). In this example, FAP #6 (marked as cell 920) may be added to the neighbor list by being detected by the cell's OOB radio, but not being detected by the NLM. Thus, in implementations in which a cell's neighbor list may be identified based on neighboring cells identified by both an NLM and an out-of-band links, the neighbor list may be as follows:

{FAP #6, FAP #7, FAP #8, FAP #2, FAP #3}

As noted, in some embodiments, various cells in a particular geographical area may exchange information using cell-to-cell communication links (e.g., backhaul links, out-of-band links, etc.) Such exchange on information may precede any small-cell network formation (e.g., before a UE starts data transmission using a formed small-cell network), and the information so exchanged between the various cell may be used to construct/form the small-area cell network. In some embodiments, exchange of information may be sent subsequent to an initial formation of a small-cell network so as to update/adjust the network's existing configuration. Thus, in some implementations, the node 910 of FIG. 9 (e.g., before or after it has established communication with the UE 902 to become the UE 902's serving node) sends its initial neighbor list, that includes first order neighbors detected by, for example, NLM or OOB mechanisms, to each of its neighbors using one or more small-area-cell-to-small-area-cell communication links. The cell 910 may also receive from each of its neighbors their first order neighbors. The cell 910 may therefore have information about small cells (in some examples, excluding the macro cells) not detected by its NLM or OOB, which are characterized as second order neighbors. In the example of FIG. 9, second order neighbors identified in the neighbor list of the serving node 910 may include:

{FAP #1, FAP #11, FAP #10, FAP #9, FAP #2, FAP #3}

In some examples, more than one first order neighbor small-area cell may report FAP #1 (marked as cell 922) as a neighbor, and, in that case, any repeated occurrence of a neighboring cell may be removed.

The determined information in relation to second-order neighboring cells can be used to identify hidden nodes, e.g., nodes that are proximate to the serving node but cannot be seen by the NLM or OOB detection units of the serving node/cell due to obstacles. For example, although the cell 922 (FAP #1) is located proximate to the serving cell 910, the cell 910 may not be able to detect it (based on the cell's 910 NLM or OOB detection units) because the cell 922 and the serving cell 910 are located on different sides of an obstacle 930 and thus do not have a direct line-of-sight awareness of each other. However, a UE 902 may be able to “see,” at its illustrated location in FIG. 9, both the serving cell 910 and the hidden cell 920. The information exchanged between small-area cells, which may include neighboring information, can therefore be used to identify hidden cells and thus to enable configuring all (or most) existing cells in a geographical area based on that information. For example, using this information can enable to avoid using the same primary scrambling code (PSC) by two or more cells within a geographical area (which could confuse a UE).

In a network (e.g., heterogeneous network) that includes small-area/low-power nodes, unplanned cell deployment and fewer primary scrambling codes (PSC) being reserved for the cells may make it difficult for an operator/HMS to provide mapping between the PSC's and cell identities. Conventional self-configuration of PSCs based on NLM measurements may not solve this problem entirely because, as noted, neighbor lists obtained by the NLM may not be complete. That is, the low-power node may not be able to detect all its neighboring FAPs by way of the NLM alone, or even with OOB detection units. However, by utilizing cell-to-cell communication links, as described herein, to exchange information between various small-area cells within a particular geographic region, a PSC re-use plan may be coordinated in a distributed fashion. That is, cell-to-cell communication can assist in obtaining the PSC, the cell identity and other broadcast information of neighboring small-area cells (low-power nodes). This information may supplement information otherwise obtained, for example, using information-gathering functionality of a cell's NLM detection unit or information from UE reports (e.g., cell ID and PSC for devices supporting 3GPP Release 9 standard, or only PSC for devices supporting pre-Release 9 3GPP standard. Thus, with this information, a small-area cell may select a PSC not used by any of its first and preferably second order neighbors. In this way, the “hidden node problem” can be reduced or eliminated, since a neighboring small-area cell would report a colliding PSC. Accordingly, automatic configuration of a network of small-area cells, for communication with one or more UE's, based on information exchanged through cell-to-cell communication links may include determining and/or assigning non-conflicting PSC to small-area cells within a geographic area (including to cells that may be hidden from a given small-area cell within the particular geographic area) in which the small-area-cell network is (or will be) formed

Automatic configuration of the small-area cells may also include determining power attributes of the various small-area cells that are included in the small-area cell network to be formed. For example, conventional NLM-based power calibration (NLPC) generally assumes that the RF conditions measured at a small-area cell are identical to those observed by users at the edge of the desired coverage range. However, there may be significant mismatches in RF conditions measured by a small-area cell(s), and those conditions observed by the UE served by the small-area cell(s). Thus, in some embodiments, neighboring small-cells may utilize the cell-to-cell communication links described herein to exchange information to improve power calibration. For example, neighboring cells may exchange measured received signal strength of neighboring small-cells and macro-cells (e.g., information such as received signal strength indication, or RSSI, which is an indication of a signal power level of a signal received by an antenna of the mobile device, pilot channel, or CPICH, measurements, received signal code power, or RSCP, measurements, etc.) Furthermore, neighboring cells may exchange location information. In some embodiments, the information exchanged between cells may include a primary scrambling code (PSC) for at least one of a first small-area cell and an identified at least one neighbor small-area cell. In such embodiments, another PSC for another of the first small-area cell and the identified at least one neighbor small-area cell may be determined based on the PSC in the exchanged information.

By basing, at least in part, power determination/calibration for individual cells on information exchanged between individual cells, area overlap regions between coverage areas may be kept to a desired extent/values. That is, dynamic transmit power calibration by small-area cells can optimize, or near-optimized, the coverage of small-area cells, reducing or preventing/inhibiting pilot pollution, and facilitating an inter-cell interference management scheme.

In another example, by utilizing the cell-to-cell communication links described herein, functionality, such as femto “self-healing” may be enabled. That is, if any small-area cell (e.g., femto-cell) is detected and determined to be non-operational by one or more neighboring cells/nodes, that information may be shared among neighboring small-area cells, such that other cells may increase or suitably adjust their transmit powers to maintain coverage. When the non-operational small cell becomes operational, the cell's restored operability is sensed/detected and the information is shared between neighboring small cells, such that other small cells may reduce their transmit power and shrink back to their original coverage. Additional configuration parameters for a particular small-area cell (such as any one of the cells depicted in FIG. 9) that may be determined based on information exchanged between the small-area cells may include the following parameters (which may be arranged in a system information block, or SIB):
femto cell ID (in implementations in which the small-area cell is a femto cell),
Downlink UMTS absolute radio frequency channel number (UARFCN),
power offset between paging indicator channel (PICH) and acquisition indicator channel (AICH),
uplink interference for the particular cell,
neighbor cell list for the particular cell, and
cell re-selection parameters, which may include:
   threshold to determine whether the particular cell is suitable for camping by a UE.
   cell reselection threshold value,
   cell reselection hysteresis value,
   cell reselection timer value, and
   maximum uplink transmit power allowed for the particular cell.

In some embodiments, an “extended femto set” (EFS) may be created. Here, the EFS may be similar to an “extended service set” (ESS) utilized in 802.11 communications. The EFS may be established based on information exchanged via cell-to-cell communication links to form a cluster. Such an EFS may enable contiguous RF coverage over a relatively large area corresponding to the cluster of small-area cells (low-power nodes), providing for seamless mobility of UEs within the cluster. In some implementations, the cluster corresponding to the EFS, and all UEs served by small-area cells in the EFS, may be viewed as a single network where all UE's are stationary. That is, the EFS can hide the mobility of the UE's within the cluster service area from other network entities outside the EFS. Thus, a HNB-GW, i.e., FAP-GW can make handover decisions within the cluster, and be the mobility anchor. Here it may be assumed that small-area cells within the EFS are open access or have the same CSG ID, and have the same LAC to avoid registrations. In this fashion, user experience corresponding to connected state mobility can be enhanced within the cluster coverage area.

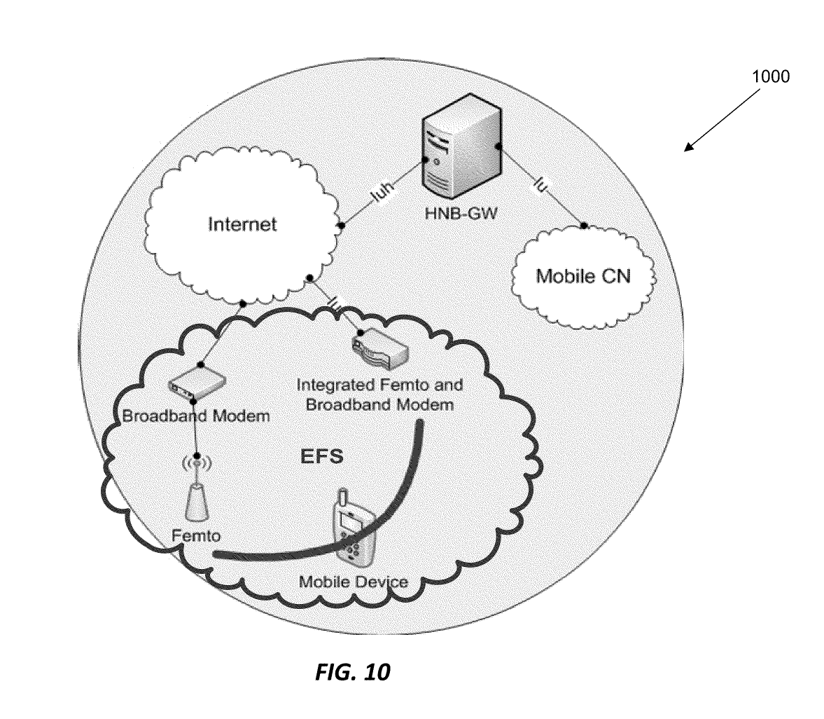

With reference now to FIG. 10, a schematic diagram showing an exemplary EFS 1000 is shown. Here, neighbor small-area cells share information with one another about proximate UE's. This can assist candidate small-area cells in the EFS to prepare resources for potential handovers as needed. Furthermore, a soft handover may be enabled as small-area cells may belong to the same FAP-GW. Still further, traffic from one small-area cell may be forwarded to another small-area cell to facilitate the inter-FAP handovers.

In some implementations, one or more of the small-area cells may be selected based on exchanged information to establish a mobile communication link between a user equipment and the selected one or more of the small-area cells. For example, this selection functionality may be based on such information as air link quality for each of the small-area cells being considered, air interface utilization for the cells being considered, backhaul utilization for the cells being considered, and/or backhaul connectivity speed for the small-area cells being considered for selection.

Thus, for example, a small-area cell may advertise (e.g., exchange cell information via a cell-to-cell communication link, such as any of the cell-to-cell links described herein) its backhaul connectivity speed (corresponding to a parameter fbᵢ, as in Hotspot 2.0 for WiFi access points), and may further advertise its current percentage of utilization of its backhaul (corresponding a parameter fbuᵢ). The variables fbᵢ and fbuᵢ may be advertised on an OOB link, e.g., a WiFi link to neighbor small-area cells. The 802.11u standard supports the Access Network Query Protocol (ANQP), which provides a range of information such as the network authentication types supported, venue name, roaming agreements in place.

In this way, small-area cell selection by a UE can be based on factors including the advertised backhaul speed fbᵢ; the percentage utilization fbuᵢ; the air interface link quality, faᵢ, from the small-area cell; and air interface utilization fauᵢ.

Such cell selection functionality can improve load-balancing within the network. Thus, in such embodiments, selection of one or more small-area cell (e.g., for connection to a UE) may include computing for each of the cells being considered a corresponding selection metric according to a relationship of:

min{(1−fbuᵢ)*fbᵢ, (1−fauᵢ)*faᵢ},

where fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell. The small-area cell that is selected (from the cells being considered) may be the one that is associated with a maximum computed selection metric.

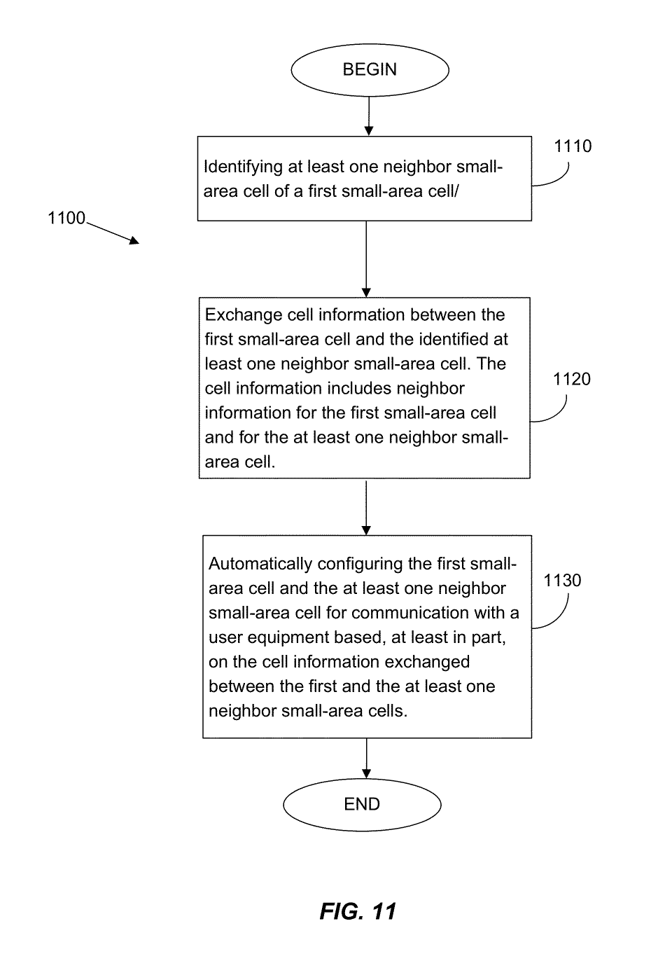

Turning now to FIG. 11, a flowchart of an example procedure 1100 for wireless communication (e.g., controlling configuration of small-area cells) is shown. The procedure 1100 includes identifying 1110 at least one neighbor small-area cell of a first small-area cell. In some embodiments, identifying the at least one neighbor small-area cell may include receiving signals from neighbor cells/nodes using such detection units as a network listen module (NLM), an out-of-band (OOB) interface, etc., and identifying or detecting such neighbor cells based on the received signals.

Having identified at least one neighbor small-area cell, information between the first small-area cell and the identified at least one neighbor small-area cell is exchanged 1120 (e.g., establishing one or more communication links between the exchanging cells, and communicating pertinent data across the one or more links). The information exchanged includes such information as neighbor information for the first small-area cell and for the at least one neighbor small-area cell. The neighbor information of the neighbor cell that is received by the first cell may include the identity of neighboring cells of the at least one neighbor cell that may not have been detected by the first cell (e.g., because they were hidden, or were too far, or for some other reason). Other information that may be exchanged may include, for example, current primary scrambling codes (PSC) assigned to the various cells, link quality and utilization attributes for each of the cells (e.g., percentage backhaul utilization for a cell, backhaul connectivity speed for the cell, air interface utilization, etc.) The information exchanged between the first cell and the at least one neighbor cell may be communicated through, for example, cell-to-cell communication links that may include backhaul communication links between the first small-area cell and the at least one neighbor small-area cell, out-of-band communication links between the first cell and its at least one neighbor cell, etc.

Based, at least in part, on the information exchanged between the first and the at least one neighbor small-area cells, the first small-area cell and/or the at least one neighbor small-area cell (and/or other of the small-area cells in a particular geographic area) are automatically configured 1130 for wireless communication with one or more UE's. Automatically configuring the various small-area cells may include assigning non-conflicting PSC's to the cells, determining transmission power levels for the cells, determining cell selection and re-selection parameters, enabling enhanced small cell selection by UEs etc. In some embodiments, automatically configuring the first small-area cell and the at least one neighbor small-area cell for communication with a user equipment may include automatically configuring the first small-area cell and the at least one neighbor small-area cell to cause adaptive cluster formation. In some embodiments, automatically configuring the cells may include determining one or more configuration parameters for the at least one of first small-area cell and the at least one neighbor small-area cell to reduce inter-cell interference.

Several aspects of telecommunications systems and methods have been described herein. It will be appreciated that various aspects described throughout this disclosure may be extended to other methods and to various types of telecommunication systems, network architectures and communication standards.

By way of example, various aspects may be used in relation to W-CDMA systems, various UMTS systems such as TD-SCDMA and TD-CDMA, etc. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed may depend on the specific application and the overall implementation constraints imposed on the system.

It is to be understood that the order or hierarchy of operations in any procedure, process or method disclosed herein is an illustration of an example procedure, process, or method, and the specific order or hierarchy of operations may be rearranged.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method of wireless communication, the method comprising:
identifying at least one neighbor small-area cell of a first small-area cell;
exchanging information between the first small-area cell and the identified at least one neighbor small-area cell, the information including neighbor information for the first small-area cell and for the at least one neighbor small-area cell; and
automatically configuring the first small-area cell and the at least one neighbor small-area cell for communication with a user equipment based, at least in part, on the information exchanged between the first and the at least one neighbor small-area cells.

2. The method of claim 1, wherein exchanging the information comprises:
performing a distributed exchange of the information between the first small-area cell and the identified at least one neighbor cell without using a central server.

3. The method of claim 1, wherein automatically configuring the first small-area cell and the at least one neighbor small-area cell comprises:
automatically configuring the first small-area cell and the at least one neighbor small-area cell prior to transmission of data traffic through one or more of the first small-area cell and the at least one neighbor small-area cell.

4. The method of claim 1, wherein automatically configuring the first small-area cell and the at least one neighbor small-area cell comprises:
determining one or more configuration parameters for at least one of the first small-area cell and the at least one neighbor small-area cell based, at least in part, on the information exchanged between the first small-area cell and the at least one neighbor small-area cell.

5. The method of claim 4, wherein determining the one or more configuration parameters for the at least one of the first small-area cell and the at least one neighbor small-area cell comprises:
determining the one or more configuration parameters for the at least one of first small-area cell and the at least one neighbor small-area cell to achieve optimal or near optimal joint small-area cell network configuration to enhance overall system performance.

6. The method of claim 5, wherein determining the one or more configuration parameters comprises:
determining the one or more configuration parameters for the at least one of first small-area cell and the at least one neighbor small-area cell to reduce inter-cell interference.

7. The method of claim 4, wherein determining the one or more configuration parameters for the at least one of first small-area cell and the at least one neighbor small-area cell comprises determining for a particular cell from the at least one of the first small-area cell and the at least one neighbor small-area cell one or more parameters including one or more of:
transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, or neighbor cell list for the particular cell.

8. The method of claim 7, wherein the cell reselection parameters for the particular cell comprise one or more of: threshold to determine whether the corresponding cell is suitable for camping, cell reselection threshold value, cell reselection hysteresis value, cell reselection timer value, or maximum uplink transmit power allowed for the particular cell.

9. The method of claim 1, wherein automatically configuring the first small-area cell and the at least one neighbor small-area cell for communication with the user equipment comprises:
automatically configuring the first small-area cell and the at least one neighbor small-area cell for communication with the user equipment to cause adaptive cluster formation based, at least in part, on the information exchanged between the first and the at least one neighbor small-area cells.

10. The method of claim 1, wherein exchanging the information comprises:
exchanging the information via a communication link comprising one or more of: an out-of-band link, or a backhaul link.

11. The method of claim 1, wherein the exchanged information further comprises:
primary scrambling code (PSC) for at least one of the first small-area cell and the identified at least one neighbor small-area cell, wherein another PSC for another of the first small-area cell and the identified at least one neighbor small-area cell is determined based on the PSC in the exchanged information.

12. The method of claim 1, wherein the neighbor information comprises first order neighbors information for each of the first small-area cell and the at least one neighbor small-area cell, wherein the method further comprises:
generating at one of the first small-area cell and the at least one neighbor small-area cell second order neighbor information based on the first order neighbors information for another of the first small-area cell and the at least one neighbor small-area cell.

13. The method of claim 1, wherein at least one of first small-area cell and the at least one neighbor small-area cell comprises a femtocell access point.

14. The method of claim 1, further comprising:
selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

15. The method of claim 14, wherein selecting the one or more of the first small-area cell and the at least one neighbor small-area cell comprises:
selecting the one or more of the first small-area cell and the at least one neighbor small-area cell based on one or more of: air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, or backhaul connectivity speed for each of the first small-area cell and the at least one neighbor small-area cell.

16. The method of claim 15, wherein selecting the one or more the first small-area cell and the at least one neighbor small-area cell comprises:
computing for each of the first small-area cell and the at least one neighbor small-area cell a corresponding selection metric according to a relationship of min{(1−fbuᵢ)*fbᵢ, (1−fauᵢ)*faᵢ}, wherein fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell; and
selecting one of the first small-area cell and the at least one neighbor small-area cell associated with a maximum computed selection metric.

17. A mobile device comprising:
one or more transceivers;
one or more processors; and
storage media comprising computer instructions that, when executed on the one or more processors, cause operations comprising:
identifying at least one neighbor small-area cell of a first small-area cell;
exchanging information between the first small-area cell and the identified at least one neighbor small-area cell, the information including neighbor information for the first small-area cell and for the at least one neighbor small-area cell; and
automatically configuring the first small-area cell and the at least one neighbor small-area cell for communication with a user equipment based, at least in part, on the information exchanged between the first and the at least one neighbor small-area cells.

18. The device of claim 17, wherein automatically configuring the first small-area cell and the at least one neighbor small-area cell comprises:
determining one or more configuration parameters for at least one of the first small-area cell and the at least one neighbor small-area cell based, at least in part, on the information exchanged between the first small-area cell and the at least one neighbor small-area cell.

19. The device of claim 18, wherein determining the one or more configuration parameters for the at least one of first small-area cell and the at least one neighbor small-area cell comprises determining for a particular cell from the at least one of the first small-area cell and the at least one neighbor small-area cell one or more parameters including one or more of:
transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, or neighbor cell list for the particular cell.

20. The device of claim 19, wherein the cell reselection parameters for the particular cell comprise one or more of: threshold to determine whether the corresponding cell is suitable for camping, cell reselection threshold value, cell reselection hysteresis value, cell reselection timer value, or maximum uplink transmit power allowed for the particular cell.

21. The device of claim 17, wherein automatically configuring the first small-area cell and the at least one neighbor small-area cell for communication with the user equipment comprises:
automatically configuring the first small-area cell and the at least one neighbor small-area cell for communication with the user equipment to cause adaptive cluster formation based, at least in part, on the information exchanged between the first and the at least one neighbor small-area cells.

22. The device of claim 17, wherein exchanging the information comprises:
exchanging the information via a communication link comprising one or more of: an out-of-band link, or a backhaul link.

23. The device of claim 17, wherein the neighbor information comprises first order neighbors information for each of the first small-area cell and the at least one neighbor small-area cell, wherein the instructions cause further operations comprising:
generating at one of the first small-area cell and the at least one neighbor small-area cell second order neighbor information based on the first order neighbors information for another of the first small-area cell and the at least one neighbor small-area cell.

24. The device of claim 17, wherein at least one of first small-area cell and the at least one neighbor small-area cell comprises a femtocell access point.

25. The device of claim 17, wherein the instructions cause further operations comprising:
selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

26. The device of claim 25, wherein selecting the one or more of the first small-area cell and the at least one neighbor small-area cell comprises:
selecting the one or more of the first small-area cell and the at least one neighbor small-area cell based on one or more of: air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, or backhaul connectivity speed for each of the first small-area cell and the at least one neighbor small-area cell.

27. The device of claim 26, wherein selecting the one or more the first small-area cell and the at least one neighbor small-area cell comprises:
computing for each of the first small-area cell and the at least one neighbor small-area cell a corresponding selection metric according to a relationship of min{(1−fbuᵢ)*fbᵢ, (1−fauᵢ)*faᵢ}, wherein fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell; and
selecting one of the first small-area cell and the at least one neighbor small-area cell associated with a maximum computed selection metric.

28. An apparatus comprising:
means for identifying at least one neighbor small-area cell of a first small-area cell;
means for exchanging information between the first small-area cell and the identified at least one neighbor small-area cell, the information including neighbor information for the first small-area cell and for the at least one neighbor small-area cell; and
means for automatically configuring the first small-area cell and the at least one neighbor small-area cell for communication with a user equipment based, at least in part, on the information exchanged between the first and the at least one neighbor small-area cells.

29. The apparatus of claim 28, wherein the means for automatically configuring the first small-area cell and the at least one neighbor small-area cell comprise:
means for determining one or more configuration parameters for at least one of the first small-area cell and the at least one neighbor small-area cell based, at least in part, on the information exchanged between the first small-area cell and the at least one neighbor small-area cell.

30. The apparatus of claim 29, wherein the means for determining the one or more configuration parameters for the at least one of first small-area cell and the at least one neighbor small-area cell comprise means for determining for a particular cell from the at least one of the first small-area cell and the at least one neighbor small-area cell one or more parameters including one or more of:
transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, or neighbor cell list for the particular cell.

31. The apparatus of claim 30, wherein the cell reselection parameters for the particular cell comprise one or more of: threshold to determine whether the corresponding cell is suitable for camping, cell reselection threshold value, cell reselection hysteresis value, cell reselection timer value, or maximum uplink transmit power allowed for the particular cell.

32. The apparatus of claim 28, wherein the means for automatically configuring the first small-area cell and the at least one neighbor small-area cell for communication with the user equipment comprise:
means for automatically configuring the first small-area cell and the at least one neighbor small-area cell for communication with the user equipment to cause adaptive cluster formation based, at least in part, on the information exchanged between the first and the at least one neighbor small-area cells.

33. The apparatus of claim 28, wherein the means for exchanging the information comprise:
means for exchanging the information via a communication link comprising one or more of: an out-of-band link, or a backhaul link.

34. The apparatus of claim 28, wherein the neighbor information comprises first order neighbors information for each of the first small-area cell and the at least one neighbor small-area cell, wherein the apparatus further comprises:
means for generating at one of the first small-area cell and the at least one neighbor small-area cell second order neighbor information based on the first order neighbors information for another of the first small-area cell and the at least one neighbor small-area cell.

35. The apparatus of claim 28, wherein at least one of first small-area cell and the at least one neighbor small-area cell comprises a femtocell access point.

36. The apparatus of claim 28, wherein the apparatus further comprises:
means for selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

37. The apparatus of claim 36, wherein the means for selecting the one or more of the first small-area cell and the at least one neighbor small-area cell comprise:
means for selecting the one or more of the first small-area cell and the at least one neighbor small-area cell based on one or more of: air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, or backhaul connectivity speed for each of the first small-area cell and the at least one neighbor small-area cell.

38. The apparatus of claim 37, wherein the means for selecting the one or more the first small-area cell and the at least one neighbor small-area cell comprise:
means for computing for each of the first small-area cell and the at least one neighbor small-area cell a corresponding selection metric according to a relationship of min{(1−fbuᵢ)*fbᵢ, (1−fauᵢ)*faᵢ}, wherein fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell; and
means for selecting one of the first small-area cell and the at least one neighbor small-area cell associated with a maximum computed selection metric.

39. A non-transitory processor readable media programmed with a set of instructions executable on a processor that, when executed, cause operations comprising:
identifying at least one neighbor small-area cell of a first small-area cell;
exchanging information between the first small-area cell and the identified at least one neighbor small-area cell, the information including neighbor information for the first small-area cell and for the at least one neighbor small-area cell; and
automatically configuring the first small-area cell and the at least one neighbor small-area cell for communication with a user equipment based, at least in part, on the information exchanged between the first and the at least one neighbor small-area cells.

40. The processor readable media of claim 39, wherein automatically configuring the first small-area cell and the at least one neighbor small-area cell comprises:
determining one or more configuration parameters for at least one of the first small-area cell and the at least one neighbor small-area cell based, at least in part, on the information exchanged between the first small-area cell and the at least one neighbor small-area cell.

41. The processor readable media of claim 40, wherein determining the one or more configuration parameters for the at least one of first small-area cell and the at least one neighbor small-area cell comprises determining for a particular cell from the at least one of the first small-area cell and the at least one neighbor small-area cell one or more parameters including one or more of:
transmit power for the particular cell, primary scrambling code (PSC) assigned to the particular cell to avoid PSC collision, femto cell ID, DL UMTS absolute radio frequency channel number (UARFCN), cell reselection parameters for the particular cell, power offset between paging indicator channel (PICH) and acquisition indicator channel (AICH), uplink interference for the particular cell, or neighbor cell list for the particular cell.

42. The processor readable media of claim 41, wherein the cell reselection parameters for the particular cell comprise one or more of: threshold to determine whether the corresponding cell is suitable for camping, cell reselection threshold value, cell reselection hysteresis value, cell reselection timer value, or maximum uplink transmit power allowed for the particular cell.

43. The processor readable media of claim 39, wherein automatically configuring the first small-area cell and the at least one neighbor small-area cell for communication with the user equipment comprises:
automatically configuring the first small-area cell and the at least one neighbor small-area cell for communication with the user equipment to cause adaptive cluster formation based, at least in part, on the information exchanged between the first and the at least one neighbor small-area cells.

44. The processor readable media of claim 39, wherein exchanging the information comprises:
exchanging the information via a communication link comprising one or more of: an out-of-band link, or a backhaul link.

45. The processor readable media of claim 39, wherein the neighbor information comprises first order neighbors information for each of the first small-area cell and the at least one neighbor small-area cell, wherein the instructions cause further operations comprising:
generating at one of the first small-area cell and the at least one neighbor small-area cell second order neighbor information based on the first order neighbors information for another of the first small-area cell and the at least one neighbor small-area cell.

46. The processor readable media of claim 39, wherein at least one of first small-area cell and the at least one neighbor small-area cell comprises a femtocell access point.

47. The processor readable media of claim 39, wherein the instructions cause further operations comprising:
selecting, based, at least in part, on the exchanged information, one or more of the first small-area cell and the at least one neighbor small-area cell to establish a mobile communication link between the user equipment and the selected one or more of the first small-area cell and the at least one neighbor small-area cell.

48. The processor readable media of claim 47, wherein selecting the one or more of the first small-area cell and the at least one neighbor small-area cell comprises:
selecting the one or more of the first small-area cell and the at least one neighbor small-area cell based on one or more of: air link quality for each of the first small-area cell and the at least one neighbor small-area cell, air interface utilization for each of the first small-area cell and the at least one neighbor small-area cell, backhaul utilization for each of the first small-area cell and the at least one neighbor small-area cell, or backhaul connectivity speed for each of the first small-area cell and the at least one neighbor small-area cell.

49. The processor readable media of claim 48, wherein selecting the one or more the first small-area cell and the at least one neighbor small-area cell comprises:
computing for each of the first small-area cell and the at least one neighbor small-area cell a corresponding selection metric according to a relationship of min{(1−fbuᵢ)*fbᵢ, (1−fauᵢ)*faᵢ}, wherein fbuᵢ represents the percentage backhaul utilization for an i^{th} small-area cell, fbᵢ represent the backhaul connectivity speed for the i^{th} small-area cell, faᵢ represents the air interface link quality for the i^{th} small-area cell, and fauᵢ represents the air interface utilization for the i^{th} small-area cell; and
selecting one of the first small-area cell and the at least one neighbor small-area cell associated with a maximum computed selection metric.
